(19) United States
(12) Patent Application Publication
(10) Pub. No.: US 2009/0038725 A1
(43) Pub. Date: Feb. 12, 2009

(54) Method and device for an inner-tube

(76) Inventor: Berty Bibas, Zur Hadasa (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/890,455

(22) Filed: Aug. 7, 2007

(51) Int. Cl. B60C 5/20

(52) U.S. Cl. 152/333.1

(57) ABSTRACT

An inner-tube divided into many isolated cells of air. Two tubes on inside circumference of said inner-tube, one for inflating air and the other for deflating air. Each cell has two one-way valves, one for filling air and the other for extracting air. The inflating valve could have an observation window or an air pressure gauge attached to it for indicating when there is a puncture in one or more of the cells of air in the inner tube.

### FIELD OF THE INVENTION

This invention is in the field of pneumatic tires and in particular an inner-tube that will not lose all its air when punctured.

### BACKGROUND OF THE INVENTION

The phenomenum of punctures in pneumatic tires is well known. The problems and dangers involved with punctures in tires applies to tubeless tires and tires with inner-tubes. When even a small hole punctures an inner-tube, the inner-tube usually loses all its air in a very short time. Tubeless tires lose their air slower when the hole is small but larger holes or gashes can cause the air to leave the tire in a few seconds. This presents a number of problems that may be divided into three main categories namely, safety, convenience and costs.

Some of the safety problems of the inner-tube are;

a. Accidents including fatal accidents caused by people changing the flat tire at the side of the road or other dangerous place where passing traffic does not see or can not see a person at the edge of his lane. This danger is increased at night.

b. Many accidents are caused by tires losing their air when the vehicle is traveling. The faster the speed at the time of the blow out, the greater the danger of an accident as the driver loses control of the vehicle.

The danger is great with motorcycles because they only have two wheels and when one of them does not function the likelihood is that the bike will fall and the rider will be thrown off. Cars can also lose control when one tire suddenly loses its air, especially when traveling at high speed.

c. There can be danger involved in having to get out of the car to deal with changing the punctured wheel with the spare wheel in places where the inhabitants are hostile.

d. There are dangers of car theft and robbery when a person is busy with exchanging the punctured tire.

Sometimes this happens when a stranger asks to “help” the driver change the wheel.

Some of the inconvenience factors involved in changing a punctured tire;
a. Changing a punctured tire is a very dirty job. It is also physically stressful which causes sweating. Sometimes it involves emptying the contents of the trunk of the car to reach the tools and spare tire. All this is usually necessary to be done in respectable clothes unsuitable for such work.
b. The above work is especially difficult for a woman and it is worrying for the husband when his wife is alone driving out of town. (It could be that the wife has no difficulty changing the wheel and she is worried when her husband is driving alone out of town, but this is the less common scenario).
c. Motorbike riders who have punctures have to order tow cars to take the bike to a tire repair shop as motorbikes do not carry spare wheels.
d. Similarly with a car that has two simultaneous punctures has to order a tow truck, which can be costly.
e. Sometimes a small hole in the tire can be temporarily fixed with cans of pressurized air and sealant material. This method of avoiding changing the wheel does not work when the puncture causes a large hole or a gash. Also it requires the driver to stop the car and work at the side of the road. This has the disadvantages and dangers as described herein.

Some of the costly aspects of state of art wheels and tires;
a. The cost of repairing punctures.
b. The cost of towing when needed.
c. The time wasted changing the wheel, whether the driver does it himself or whether he has to drive to a professional repair workshop and wait until the repair is complete.
d. The cost of replacing damaged clothes.

These problems are solved or at least to a large extent alleviated by the present invention as is now revealed.

### SUMMARY of the INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but the not to limit the invention to these descriptions only.

It is not possible with present technology to have a rubber based pneumatic tire of normal thickness that is impervious to sharp objects. This means that punctures will occur in such tires.

One object of this invention is to enable the effect of a puncture on driving to be sufficiently small that the driver will be able to continue to drive normally after the tire has been punctured. The vehicle will be able to be driven to its destination and at a later time, not necessarily that day, the vehicle could be taken to a tire repair workshop. This would avoid the present need to immediately take time to deal with the puncture and avoid the various other disadvantages of the current art as described in the Background herein. Furthermore, more than one puncture on the same tire or a different tire could be repaired at the same time, thereby saving visits to the repair workshop.

The inner-tube is divided into three main sections, namely the outer tube that is divided into many small independent cells, an inflation tube that is used for filling air into the said cells and a deflation tube that is used for emptying the air out of the said cells.

The inflation tube and deflation tube are to avoid the tedious task of filling or emptying air in or out of each air cell independently.

Each cell would have two one-way air valves, one to let air into the cell and the other to let air out of the air cell. There could be about fifty cells in an inner-tube where each cell is about five centimeters wide. These numbers and measurements would vary from tire to tire depending on size and other factors.

There would be one place to fill the inner-tube namely a one-way valve in the inflation tube. The valve would be accessible to the outside of the tire so that an air pump connection could be made as is common on tires in the art. The incoming pressurized air would enter the inflation tube and from there enter the individual air cells through the one-way valve between the inflation tube and each cell. This way all the cells of air would be filled with air at the same pressure. Air pressure would remain in the inflation tube provided no cell was punctured.

In a case where there is a need to empty the inner-tube from its air, the one-way valve exiting from the deflation tube would be opened. This exiting air would cause the pressure to drop in the deflation tube and the air from all the air cells would exit from the one-way exit valve in each cell.

Another object of this invention is to be able to observe whether one of the inner tube cells has been punctured. This observation could be done externally without removing the inner tube from the wheel rim. There could be a manual pressure indicator or gauge or a digital pressure gauge. When this indicator or gauge is attached to the inflation tube there will be a significant and noticeable drop in pressure when one of the cells of the inner tube is punctured.

Another object of this invention is for the inner-tube with its cell making width divisions, to be divided centrally longitudinally perpendicularly to the width divisions. This would double the number of cells to around one hundred cells, depending on the size of the wheel. In this embodiment when there is a puncture of one cell there would be a loss of air to the tire of only around one percent of the fully inflated tire.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a schematic depiction of the sectional view of an inner-tube with divisions into cells.

FIG. 2 a portion of the inner-tube of FIG. 1 enlarged.

FIG. 3 is a schematic depiction of the cross sectional view of another embodiment of the inner-tube of this invention.

FIG. 4 is a schematic depiction of a valve of the inner tube.

FIG. 5 is plan view of the inner tube.

FIG. 6 is an embodiment of the inner tube with a longitudinal division in addition to the divisions across the width of the inner tube.

FIG. 7 is a schematic depiction of the cross sectional view of the embodiment of the inner-tube with the addition of the longitudinal division.

FIG. 8 is a schematic depiction of a valve cover of the valve where air exits.

FIG. 9 is a schematic depiction of the double valve of this invention with a pressure gauge attached.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

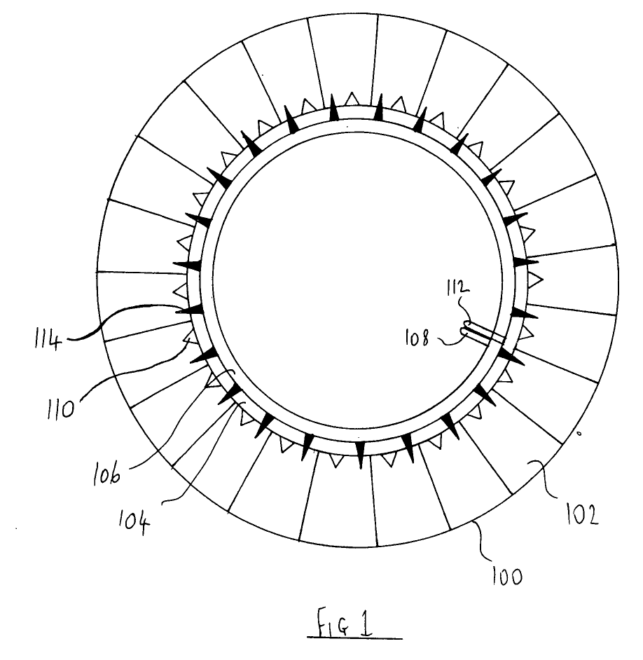

FIG. 1 shows an inner-tube of this invention 100 whose outer section is divided into many cells 102. There are two more small sized tubes adjacent to the main tube 102, namely the inflation tube 104 and the deflation tube 106. The inflation tube 104 is for filling the inner-tube with air. The air pump connection main valve 112 is capable of being coupled with an air pump that would pump in air to the inflation tube 104 and from there the air would flow through the one way valves 110 into the individual cells 102. The one way valves 110 allow air to enter but not exit from the cells 102. The main air exit valve 108 is used to remove air from the inner tube 100. The air exit valves 114 connect each cell with the deflation tube 106. When the air in tube 106 is released by opening the main valve 108 the air in the cells 102 will also exit to the tube 106 and from there exit via main valve 108.

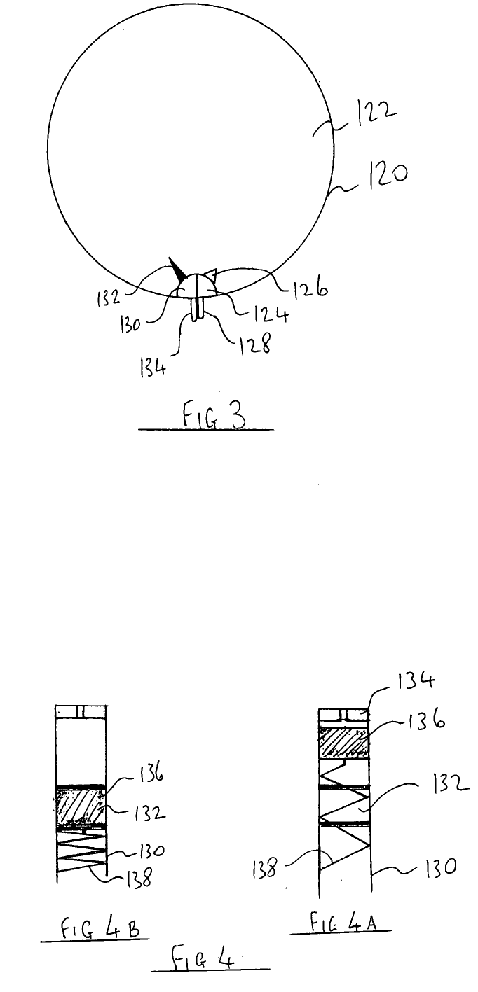

The air pump connection main valve 112 could have an indicator to show if one or more of the air cells 102 had a puncture. This indicator is described in more detail in FIG. 4 and FIG. 9.

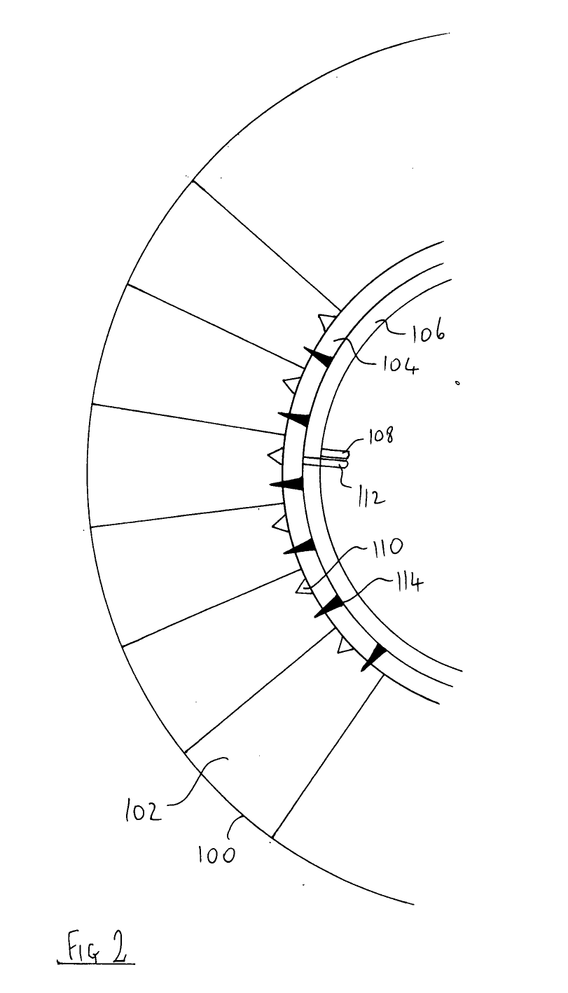

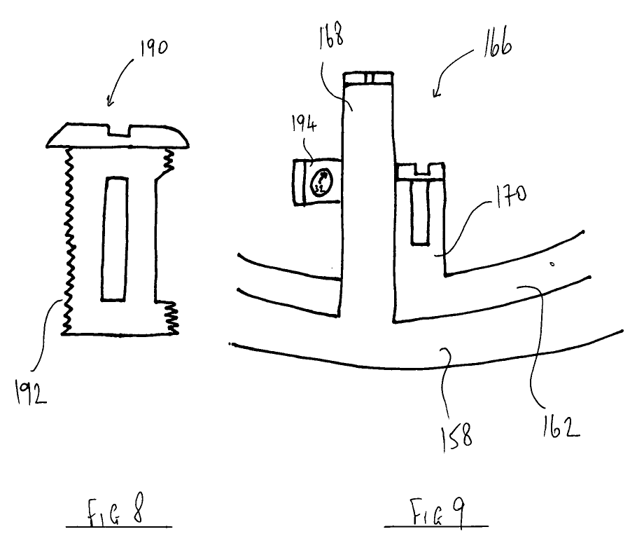

FIG. 2 is an enlarged version of a portion of FIG. 1. The inner tube 100 has the main portion of the inner tube divided into many cells 102. The one way valve 110 only lets air enter the cell 102. The one way valve 114 only lets air exit from the cell 102. The air entering is held in the inflation tube 104 and the air exiting is held in the deflation tube 106. Air under pressure is used to pump up the inner tube 100 and that is done via the air pump connection main valve 112. When air is required to exit, the main valve 108 is opened and the air from tube 106 and from all the cells 102 will exit as is described in more detail in FIG. 8 and FIG. 9.

FIG. 3 shows the cross section 120 of another embodiment of this invention. In this embodiment the two additional tubes used for filling and emptying the main tube 122 are inside the main tube 122 adjacent to the outer wall of the main tube 122. The inflation tube 124 used for blowing up the main tube 122 has a one way inlet valve 126. The deflation tube 130 has a one way outlet valve 132.

The main tube 122 is divided into many cells as described in FIG. 1. The FIG. 3 120 is the cross sectional view of one such cell. There would be one inlet valve 126 and one outlet valve 132 in each cell.

There is one main one-way valve 128 for enabling air to be pumped into the main tube 122 and one main one-way valve 134 for enabling air to exit the main tube 122. These two main valves 128 and 134 could form a double valve and be accessible from the wheel of the vehicle without removing the inner tube from the wheel rim.

FIG. 4 shows how the one way inlet valve neck 130 (FIG. 1 112 and FIG. 3 128) can indicate if one or more of the cells FIG. 1 102 have been punctured.

FIG. 4A shows an enlarged sectional view of the inlet valve neck 130 with an observation window 132. Air is pumped into the tire through the main valve connection 134. There is a one way valve 136 that only lets air into the tube but does not let air exit. The valve 136 is able to move up and down inside the neck 130. The air pressure in the inflation tube FIG. 1 104 and FIG. 3 124 would keep the valve 136 at the end of the neck 130 nearest the main valve connection 134. A spring 138 would be extended when the air pressure is high. When there is no puncture, the air would enter each cell of the main inner tube FIG. 1 102 from the inflation tube FIG. 1 104 and high pressure would remain in inflation tube FIG. 1 104.

FIG. 4B shows the inlet valve neck 130 when one of the cells in the main inner tube has been punctured. As soon as one cell FIG. 1 102 is punctured the pressure in that cell would fall and the higher pressure in the inflation tube FIG. 1 104 would enter the punctured cell through the one way valve 110. This would have the effect of significantly reducing the pressure in the inflation tube causing the one way valve 136 to drop with the aid of the spring 138 retracting. This movement of the one way valve 136 could be observed in the observation window 132, indicating to the observer that at least one cell has been punctured.

FIG. 5 is a plan view of the inner-tube 100 divided into cells 102. The inflation tube 104 has one way valves 110 in each cell to let air into the cells 102. The deflation tube 106 has one way valves 114 in each cell to allow air to exit from the cells. The double valve (not in plan view in the same plain as the rest of the drawing but is at 90° facing towards the center of the wheel) has one main one-way valve 112 for blowing air into the inflation tube 104 and main one-way valve 108 for allowing air to exit.

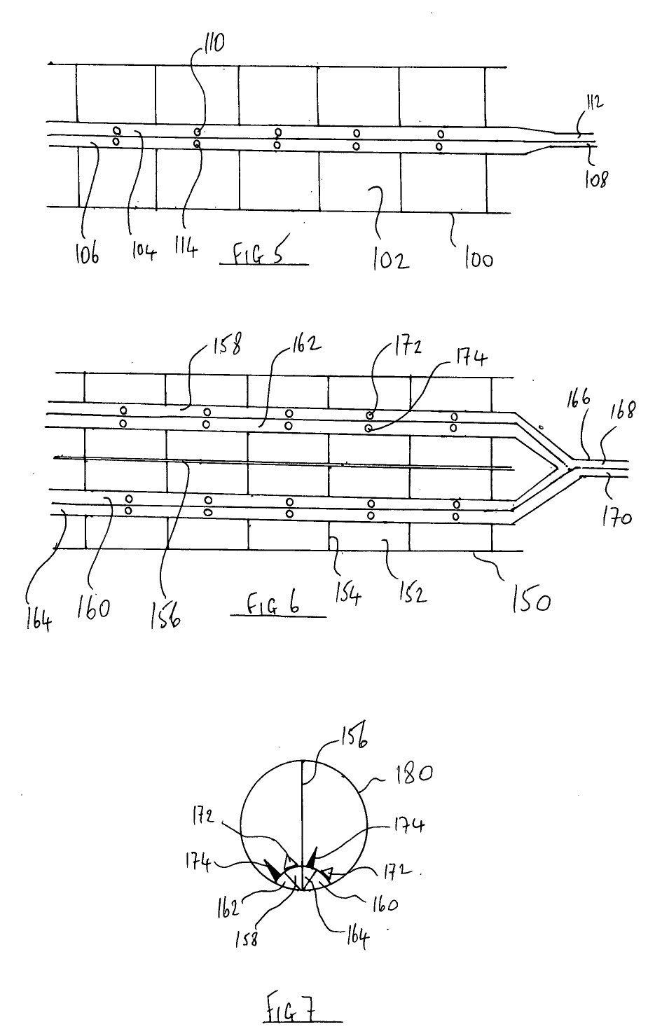

FIG. 6 is a plan view of the embodiment of the inner-tube where the cells are divided into two thereby doubling the number of air cells and halving the adverse effect of driving on the tire when one cell has been punctured. The inner-tube 150 of this embodiment has is divided into cells 152 by circular dividers 154 across the width of the tube 150 and a divider 156 dividing those width formed cells into two cells each. The divider 156 is on the central longitudinal axis of the tube 150.

There are two parallel inflating tubes 158 and 160 and two parallel deflating tubes 162 and 164. The two inflating tubes 158 and 160 join to form one half of the double valve 166 (not in plan view in the same plain as the rest of the drawing but is at 90° facing towards the center of the wheel) having one main one-way valve 168 for blowing air into the inflation tubes 158 and 160. Similarly, with the deflating tubes 162 and 164 that merge to form the other half of the double valve 166 having one main one-way valve 170 that enables air to escape when that is desirable.

Each cell 152 has in it a one way inflating valve 172 attached to the inflating tubes 158 and 160 to allow air pumped into the inflation tubes 158 and 160 to enter the cells 152. Similarly, each cell 152 has in it a one way deflating valve 174 attached to the deflating tubes 162 and 164 to allow air to exit when that is desired.

FIG. 7 shows the cross section of one cell of FIG. 6 152. The four additional tubes, two used for filling 158 and 160 the main tube 180 and two used for allowing air to escape 162 and 164 the main tube 180, are inside the main tube 180 adjacent to the outer wall of the main tube 180. Each inflation tube 158 and 160 has a one way inlet valve 172. Each deflation tube 162 and 164 has a one way outlet valve 174.

The main tube 180 is divided along its longitudinal axis by a divider 156.

FIG. 8 shows a main valve air release cover 190 that would cover the main valve for release of air FIG. 1 108, FIG. 3 134, FIG. 5 108 and FIG. 6 170. The valve cover 190 could have a screw and thread mechanism 192 for attachment means and for controllably releasing air from the deflating tubes FIG. 5 106 or FIG. 6 162 and 164. That is to say, by unscrewing the valve cover 190 air would be released from escape the main air release valves FIG. 1 108, FIG. 3 134, FIG. 5 108 and FIG. 6 170.

FIG. 9 shows an inflating tube 158 and a deflating tube 162. The double valve 166 comprises the inflating valve 168 and the deflating valve 170. The valve cover 190 covers the main deflating valve 170.

Attached to the inflating valve 168 could be a pressure gauge 194 that would indicate the pressure in the inflation tube 158. The pressure gauge 194 would be attached to the inflating valve because when there is no puncture the inner tube pressure will remain high. However, if one of the cells of the inner-tube were to be punctured the pressure gauge reading would drop significantly as the air leaves that cell and the air pressure in the inner tube would leave the inner tube by going through the one way valve in that punctured cell and out through the puncture hole. If the pressure gauge 194 were attached to the deflating valve and one of the cells were punctured the drop in pressure would be insignificant and much harder to detect. The pressure gauge 194 could be used to show the pressure in the tire when filling the inner-tube with air but thereafter the gauge 194 would not necessarily indicate the pressure in the tire but rather be an indicator to show when the first cell FIG. 6 152 has been punctured. The pressure reading on the gauge 194 would drop from full pressure to zero or close to zero.

What is claimed:

1. A method and device for an inner tube of a vehicle wheel comprising;
a. dividers to divide the said inner tube into cells, being separate isolated compartments,
b. an accessory tube for inflating the said cells with air,
c. a one-way main valve in the said inflation accessory tube with access to the said valve from the exterior of the said wheel and with a means to connect to an air pump connector for the purpose of inflating the said inflation accessory tube and the said cells,
d. an accessory tube for deflating the said cells from their air,
e. a one-way main valve in the said deflation accessory tube with access to the said valve from the exterior of the said wheel and with a means to release air from the said deflation accessory tube for the purpose of deflating the air in the said deflation accessory tube and from the said cells,
f. one one-way air valve in each said cell for air to pass in one direction only from the said inflation accessory tube into the said cell,
g. one one-way air valve in each said cell for air to pass in one direction only from the said cell to the said deflation accessory tube, whereby an inner tube could be punctured without all the air therein escaping and whereby all the said cells in an inner tube could be inflated from one main valve and all the cells in an inner tube could be deflated from one main valve.

2. A method and device for an inner tube as claimed in claim 1 further comprising an observation window in the said one way main valve to observe the different positions of a moveable indicator indicating when there is high pressure in the said inflation accessory tube and when there is low pressure in the said inflation accessory tube.

3. A method and device for an inner tube as claimed in claim 1 wherein the said inflation accessory tube and the said deflation accessory tube are adjacent one to the other on the outer side of the inside rim of the said inner tube.

4. A method and device for an inner tube as claimed in claim 1 wherein the said inflation accessory tube lies between the said inner tube and the said deflation accessory tube, on the outer side of the inside rim or the said inner tube.

5. A method and device for an inner tube as claimed in claim 1 wherein the said inflation accessory tube and the said deflation accessory tube are adjacent one to the other on the inner side of the inside rim of the said inner tube.

6. A method and device for an inner tube comprising;
a. dividers to divide the said inner tube into cells, being separate isolated airtight compartments,
b. an accessory tube for inflating the said cells with air,
c. a one-way main valve in the said inflation accessory tube with a means to connect to an air pump connector for the purpose of inflating said inflation accessory tube and the said cells,
d. one one-way air valve in each said cell for air to pass in one direction only from the said inflation accessory tube into the said cell,
whereby an inner tube could be punctured without all the air therein escaping and whereby all the said cells in an inner tube could be inflated from one valve.

7. A method and device for an inner tube as claimed in claim 6 further comprising an observation window in the said one way main valve to observe the different positions of a moveable indicator indicating when there is high pressure in the said inflation accessory tube and when there is low pressure in the said inflation accessory tube.

8. A method and device for an inner tube as claimed in claim 7 wherein the said observation window is situated in the neck of the one way valve of the said inflation accessory tube whereby a moveable part in the said valve neck moves according to different air pressures in the said inflation accessory tube and the said movement is observable.

9. A method and device for an inner tube as claimed in claim 8 wherein the said air pressure is observed on a digital screen.

10. A method and device for an inner tube of a vehicle wheel comprising;
a. dividers across the width of the said inner-tube to divide the said inner tube into cells, being separate isolated compartments,
b. a divider to divide the said inner-tube along its circular length thereby dividing each said cell into two separate isolated half size cells,
c. at least one accessory tube for inflating the said half size cells with air,
d. a one-way main valve in the said inflation accessory tube with access to the said main valve from the exterior of the said wheel and with a means to connect to an air pump connector for the purpose of inflating said inflation accessory tubes and the said half size cells,
e. at least one accessory tube for deflating the said half size cells from their air,
f. a one-way main valve in the said deflation accessory tubes with access to the said main valve from the exterior of the said wheel and with a means to release air from the said deflation accessory tubes for the purpose of deflating the air in the said deflation accessory tube and from the said half size cells,
g. one one-way air valve in each said half size cell for air to pass in one direction only from the said inflation accessory tube into the said half size cell,
h. one one-way air valve in each said half size cell for air to pass in one direction only from the said half size cell to the said deflation accessory tube, whereby an inner tube could be punctured without all the air therein escaping and whereby all the said half size cells in an inner tube could be inflated from one valve and all the said half size cells in an inner tube could be deflated from one valve.

11. A method and device for an inner tube as claimed in claim 10 wherein the number of accessory tubes for inflating the said half size cells with air is two.

12. A method and device for an inner tube as claimed in claim 10 wherein the number of accessory tubes for deflating the said half size cells with air is two.

13. A method and device for an inner tube as claimed in claim 10 wherein the said inflation accessory tubes and the said deflation accessory tubes are adjacent one to the other on the inner side of the inside rim of the said inner tube.

14. A method and device for an inner tube as claimed in claim 10 further comprising an observation window in the said one way main valve to observe the different positions of a moveable indicator indicating when there is high pressure in the said inflation accessory tube and when there is low pressure in the said inflation accessory tube.

15. A method and device for an inner tube as claimed in claim 10 further comprising an observation window that indicates a change in pressure when the air pressure in at least one said half size cell drops.

16. A method and device for an inner tube as claimed in claim 14 wherein the said air pressure is observed on a digital screen.

17. A method and device for an inner tube as claimed in claim 1 further comprising a valve cover over the said main valve for deflating the said deflating accessory tube with a manual movement of the said valve cover.

18. A method and device for an inner tube as claimed in claim 17 wherein the said valve cover seals the said valve with a twisting screw movement and releases air from the said valve with a twisting screw movement in the opposite direction.

19. A method and device for an inner tube as claimed in claim 10 further comprising a valve cover over the said main valve for deflating the said deflating accessory tube with a manual movement of the said valve cover.

20. A method and device for an inner tube as claimed in claim 19 wherein the said valve cover seals the said valve with a twisting screw movement and releases air from the said valve with a twisting screw movement in the opposite direction.
